(19) United States
(12) Patent Application Publication
(10) Pub. No.: US 2018/0305795 A1
(43) Pub. Date: Oct. 25, 2018

(54) Tube for Use in Conjunction with a Deep Drilled Hole

(71) Applicant: Otto Fuchs Kommanditgesellschaft, Meinerzhagen (DE)

(72) Inventors: Joachim Becker, Meinerzhagen (DE); Peter Kaufmann, Meinerzhagen (DE); Reinhart Domke, Meinerzhagen (DE); Thomas Witulski, Meinerzhagen (DE)

(21) Appl. No.: 15/765,203

(22) PCT Filed: Nov. 25, 2015
(86) PCT No.: PCT/EP2015/077622

§ 371 Date: Mar. 30, 2018

(51) Int. Cl. C22C 21/16; C22F 1/057; B21C 23/00; B21C 23/08; B21C 37/16; F16L 9/00

(52) U.S. Cl. CPC C22C 21/16; C22F 1/057; B21C 23/002; E21B 17/00; B21C 37/16; F16L 9/006; B21C 23/085

(57) ABSTRACT

A tube for use in conjunction with a deep drilled hole comprises a light metal tube made of an aluminium alloy, having sections of different wall thicknesses arranged in the longitudinal direction of the tube and a respective coupling at each end for connecting the tube to a further tube, wherein the light metal tube is produced from an aluminum alloy containing the following elements: 2.5-5.0 wt. % Cu, 0.2-1.0 wt. % Mg, 0.8-2.0 wt. % Li, max. 0.15 wt. % Si, max. 0.15 wt. % Fe, max. 0.5 wt. % Mn, max. 1.0 wt. % Zn, max. 0.1 wt. % Ti, max. 0.5 wt. % Ag, the remainder being Al and unavoidable impurities. Also described is a method for producing a light metal tube for a tube of this type configured for example as a bore tube. Said method comprises the steps of forming the light metal tube by means of an extrusion method and subsequent solution annealing, then drawing out the extruded tube over the entire length thereof, until the section or sections having the smallest wall thickness are drawn out by at least 2 to 2.5%, and the drawn light metal tube is artificially aged in a subsequent process step at a temperature of between 164° C. and 180° C.

### BACKGROUND

The present disclosure relates to a tube for use in conjunction with a deep drilled hole, comprising a light metal tube made of an aluminum alloy, having sections of different wall thicknesses arranged in the longitudinal direction of the tube and a respective coupling at each end for connecting the tube to a further tube. The present disclosure further relates to a method of producing a light metal tube for such a tube.

Bore tubes are an example of tubes commonly used to form a drill rod assembly for deep drilled holes in oil and gas exploration and extraction. Such tubes can also be used to form a riser and/or a borehole casing. Such tubes are also used for deep drilled holes which serve other purposes, such as water extraction or heat recovery. For executing a drilling, a multitude of such bore tubes are needed, each having a coupling at their ends. The tube couplings are either separate components which are connected to the tube or inserted in the ends of the tubes. These tube couplings are connected as the borehole advances and form a drill rod assembly. The drill rod assembly and the tubes installed within it must withstand the forces which act on them. These mainly involve the transmission of a torque required for advancing the hole, which must be coupled into the drill rod assembly and transmitted via the same to the drill head. Such drill rod assemblies can be several kilometers long. Such a drill tube must also resist axial tensile loads, which mainly act on the drill rod assembly when it is pulled out. In addition to the mechanical stress, such drill tubes are also exposed to chemical stresses in the hole, due to the action of circulation fluid and the substances dissolved in it. The same applies when the tubes are used as risers and/or casing.

Drill tubes made of high-strength steel alloys meet these requirements; but, their disadvantage is that the weight of the drill rod assembly is considerable, especially for longer drill rod assemblies. To remedy this, drill tubes were developed which comprise of a light metal tube with coupling pieces, typically made of steel, connected to their ends. Such drill tubes are more lightweight than steel tubes due to the considerably lower specific weight of aluminum alloy compared to steel. This has a positive effect on transporting and handling drill tubes at or on the drilling rig, and on the drive unit which is needed to drive the drill rod assembly. If coupling pieces are used as couplings, these are typically attached to the respective end of a light metal tube using a shrink-fitting process. Such a drill tube comprising a light metal tube and steel couplings connected to the ends thereof is known from DE 11 48 508.

An aluminum alloy of the AA 2014 or AA 7075 type is used to produce the light metal of the aforementioned drill tube. Both alloys are high-strength aluminum alloys, which get their strength from a special alloy composition and hot curing process. Such light metal tubes are typically produced by extrusion. The extruded tubes are then drawn out by 1 to 1.5% to eliminate any curvature that might have been introduced. Finally, the drawn out light metal tubes are artificially aged. The type AA 2014 alloy is an aluminum alloy of the AlCu4SiMg type. The type AA 7075 alloy is an aluminum alloy of the AIZn5.5MgCu type.

In a recent development of light metal drill tube manufacturing, the light metal tubes, or “tailored tubes”, are produced with sections of different wall thicknesses in the longitudinal extension. The light metal tube of such a drill tube typically has three sections consisting of a greater wall thickness separated from one another by a section with a smaller wall thickness. Two of the sections have greater wall thickness from the end sections of the tube. These sections have greater wall thickness than the adjacent section, such that they can be machined in subsequent processing steps for connecting the couplings. A third section of greater wall thickness is at the center between the two end sections and serves as a wear pad. The transitions between the sections of different wall thicknesses are continuous. To produce such light metal tubes for a drill tube of the aforementioned type with the required strength, it is deemed necessary to use an aluminum alloy which gets the required strength due to the composition of the alloy and its artificial aging capacity to ensure that all components of the tube have the same strength values.

In addition to type AA 2014 or AA 7075 aluminum alloys, other know high-strength aluminum alloys get their strength in a drawing process. Such aluminum alloys are sensitive to drawing, an example being longitudinals used for aircraft components. Such components have a consistent wall thickness over their longitudinal extension, such that the desired strength values can be set by the drawing process over the entire length of the component. But this cannot be done in components having sections of different wall thicknesses in their longitudinal extension and drawing direction. A drawing process will, depending on the difference in wall thickness, predominantly or even exclusively draw out those sections with a smaller wall thickness.

Even if the type AA 2014 or AA 7075 aluminum alloys can be used to produce light metal tubes having sections of different wall thicknesses for producing a drill tube with strength properties currently deemed sufficient, these strength values do not match those of steel drill tubes. This means that light metal tubes cannot be used for deeper holes, which necessitate a longer drill rod assembly, but these are precisely the applications for which light metal tubes would be particularly desirable. If the strength of the drill tubes is insufficient, the drilling operation can only be performed at a limited torque. This has an adverse effect on drilling performance. In addition, the corrosion resistance of light metal tubes made of these aluminum alloys has proved unstable, particularly in the corrosive environment of a drill hole and the circulating fluid contained therein. This is undesirable in drilling practice, since corrosion cannot be controlled, and the drill tubes used must be subjected to frequent corrosion inspections.

The foregoing examples of the related art and limitations therewith are intended to be illustrative and not exclusive. Other limitations of the related art will become apparent to those of skill in the art upon a reading of the specification and a study of the drawings.

### SUMMARY

Proceeding from the foregoing, an aspect of the present disclosure is to propose a tube for use in conjunction with deep drilled holes, for example designed as a drill tube, comprising a light metal tube made of an aluminum alloy, a method of producing such a tube having improved properties compared to conventional type AA 2014 or AA 7075 aluminum alloy light metal tubes, and may be suitable for producing tubes having sections of different wall thicknesses. The following embodiments and aspects thereof are described and illustrated in conjunction with systems, tool and methods which are meant to be exemplary and illustrative, not limiting in scope. In various embodiments, one or more of the above described problems have been reduced or eliminated, while other embodiments are directed to other improvements.

This problem is solved by a tube of the generic type mentioned above as provided, in which the light metal tube is made of an aluminum alloy having the following composition:

### 2.5-5.0 wt % Cu,

### 0.2-1.0 wt % Mg,

### 0.8-2.0 wt % Li,

### max. 0.15 wt % Si,

### max. 0.15 wt % Fe,

### max. 0.5 wt % Mn,

### max. 1.0 wt % Zn,

### max. 0.1 wt % Ti,

### max. 0.5 wt % Ag,

remaining aluminum and unavoidable impurities.

The alloy compositions described within this specification may contain unavoidable impurities of 0.05 wt % per element, wherein the overall quantity of impurities should not exceed 0.15 wt %. But, it is preferred that the impurities are kept as low as possible, such that they do not exceed 0.02 wt % per element and an overall quantity of 0.8 wt %.

The method-related problem is solved by a method in which the light metal tube is formed using an extrusion process and subsequently solution annealed. The extruded tube is then drawn out over its entire length until the section or sections having the smallest wall thickness are drawn out by at least 2 to 2.5%. The drawn light metal tube is then artificially aged in a subsequent process step at a temperature between 164° C. and 180° C.

In the concept of the claimed tube and the aforementioned method of producing the light metal tube, the inventors overcame the bias described above as provided that aluminum alloys sensitive to drawing cannot be used for tubes having sections of different wall thicknesses. Indeed, the aluminum alloy is typically produced in an extrusion process and is sensitive to drawing, therefore necessitating that the components made thereof be drawn out and meet special strength requirements. The same applies to the tubes claimed herein, as these tubes are meant for use in conjunction with deep drilled holes, for example, as drill tubes.

A light metal tube made of this alloy will have improved strength values and corrosion-resistance in a bore hole whether the tube has sections with different wall thicknesses in its longitudinal extension or not. This is a substantial advantage, specifically for practical application. The strength values can be improved by more than 20%, typically even by 30-50%. A critical variable, particularly for tubes used in conjunction with deep drilled holes, is their stress corrosion cracking resistance. Stress corrosion cracking resistance is significantly improved compared to conventional tubes made of an AA 7075 aluminum alloy. The tubes according to the present disclosure also show improved stress corrosion cracking resistance compared to tubes made of an AA 2014 aluminum alloy. Tests have revealed that it is more than three times better than a tube made of an AA 2014 aluminum alloy. Fatigue strength is also improved in a tube comprised of a light metal alloy as claimed.

In addition, the different drawing behavior of a light metal tube made of such an alloy and having wall sections of different wall thicknesses can shrewdly be used before the artificial aging process is performed to finally set their strength. Drawing out the sections of a smaller wall thickness by at least 2-2.5%, preferably even by 4-4.5% and more, which drawing specifications refer to as having the smallest wall thickness, causes just minor to no drawing out of sections having a greater wall thickness. This is dependent on the difference in wall thickness between the sections with a smaller wall thickness and those with a greater wall thickness. The result is that sections with a greater wall thickness are less affected by the drawing process or not affected at all. The final strength, including that of sections with a greater wall thickness, is set during the subsequent process of artificial aging and the associated hardening. The strength values obtained in this manner are typically lower than those that can be observed as a result of drawing out the sections with a smaller wall thickness. But this is not a problem, since the lower strength in these sections are compensated by their greater wall thickness. In this respect, the inventors, by the concept of their present disclosure, have also overcome the common belief that a drill tube having different wall thicknesses must have a uniform material strength over its entire length.

AA 2195 is an example of a suitable aluminum alloy for producing such a light metal tube.

Assuming that the typical artificial aging for such an AA 2195 alloy at 153° C. is performed, sufficient strength properties can be achieved for the light metal tube to be used, for example, as part of a drill tube, if the difference in wall thickness between the section with the smallest wall thickness and that with the greatest wall thickness is smaller than 1.2. A new artificial aging process has been developed to ensure sufficient strength properties of a tube made of such an aluminum alloy if the wall thickness of the sections with a greater wall thickness is more than 1.2 times that of the sections with a smaller wall thickness. This concept also takes into account that the time needed for artificial aging should not be excessively long to avoid driving up manufacturing costs unnecessarily. Sufficient strength properties for a light metal tube made of the alloy according to the present disclosure and having individual sections of different wall thicknesses can also be achieved for greater wall thickness differences if the artificial aging is performed at an increased temperature, namely between 164° C. and 180° C., typically for 24-38 hours. Artificial aging for 36 hours at 170° C. or approximately 170° C. is particularly preferred.

It was known based on an aspect of the artificial aging process for AA 2195 in the aforementioned disclosures, which is performed at 153° C. according to specifications, that the final strength that can be achieved decreases at higher artificial aging temperatures. But it is unexpected that, if artificial aging is performed in the temperature range mentioned, convergence of the strength values of the sections that are less drawn out or not at all drawn out and those sections that were drawn out to a maximum extent is improved. Thus, the difference in strength properties between the sections of the light metal tube is relatively low. In each case, this method can be used to achieve strength properties that are improved compared to those of a conventional light metal tube, even in sections that were not drawn out.

Particularly favorable properties can be achieved for a light metal tube if the aluminum alloy exclusively comprises the aforementioned alloying elements in the percentages claimed.

Properties can be further improved in a tube of the type in question for the purposes of manufacturing a light metal tube and their planned use in conjunction with a deep drilled hole if the light metal tube is made of an alloy having the following alloying elements:

### 3.5-4.5 wt % Cu,

### 0.2-0.8 wt % Mg,

### 0.8-1.3 wt % Li,

### 0.1-0.4 wt % Mn,

### 0.02-0.07 wt % Ti,

### max. 0.15 wt % Si,

### max. 0.15 wt % Fe,

remaining aluminum and unavoidable impurities.

In another embodiment of this alloy composition, the magnesium portion can be between 0.28 and 0.4 wt % and the manganese portion is between 0.01 and 0.25 wt %.

The manganese content of this alloy can affect another increase in the strength of the light metal tube.

In an alternative embodiment, the following alloy composition is used:

### 3.5-4.5 wt % Cu,

### 0.2-0.8 wt % Mg,

### 0.8-1.3 wt % Li,

### 0.1-0.4 wt % Mn,

### 0.02-0.07 wt % Ti,

### 0.2-0.5 wt % Ag,

### max. 0.15 wt % Si,

### max. 0.15 wt % Fe,

### max. 0.5 wt % Ag,

remaining aluminum and unavoidable impurities.

In this alloy, the silver content causes the increase in strength. The silver-containing variant will presumably not be used for industrial purposes for cost reasons. Addition of the silver element has the same effect in the alloys mentioned above as well.

The presence of lithium in the alloy not only increases strength but keeps the specific weight low as well. The alloys mentioned above have a specific weight which is a few percentage points lower than the specific weight of the AA 2014 alloy.

The lithium content is adapted to the copper and magnesium contents of the alloy in such a manner that a specific lithium portion is incorporated in the alloy but only as much as to bring it into solution and prevent the formation of undesirable lithium-containing phases. For this reason, the lithium content of the alloy is limited to a narrow range between 0.8 and 2.0 wt %.

Magnesium contributes to the desired properties of the tube made of this alloy but is only allowed at the percentage mentioned to prevent the formation of undesirable phases (such as the S phase AI₂CuMg). With a view to the other alloying elements, the Mg content should not exceed 1.0 wt %.

The allowed Fe and Si percentages are mostly introduced to the alloy as impurities due to the recycling of precursors. These do not impair the desired properties of the light metal tube produced from the alloy.

In addition to the aspects and embodiments described above, further aspects and embodiments will become apparent by reference to the accompanying drawings and the detailed description forming a part of this specification.

### BRIEF DESCRIPTION OF THE DRAWINGS

The present disclosure is described below using an exemplary embodiment and with reference to the enclosed figures. Wherein:

FIG. 1: shows a schematic longitudinal section of a light metal tube,

FIG. 2: shows a diagram of the yield strength development over the artificial aging performed according to the present disclosure,

FIG. 3: shows a diagram of the yield strength development over the artificial aging time for artificial aging at conventional conditions, and

FIG. 4: shows a diagram representing the flow point or tear resistance of a tube in the present disclosure combined with its drawing-out ratio.

Before further explaining the depicted embodiments, it is to be understood that the invention is not limited in its application to the details of the particular arrangements shown, since the invention is capable of other embodiments. It is intended that the embodiments and figures disclosed herein are to be considered illustrative rather than limiting. Also, the terminology used herein is for the purposes of description and not limitation.

### DETAILED DESCRIPTION

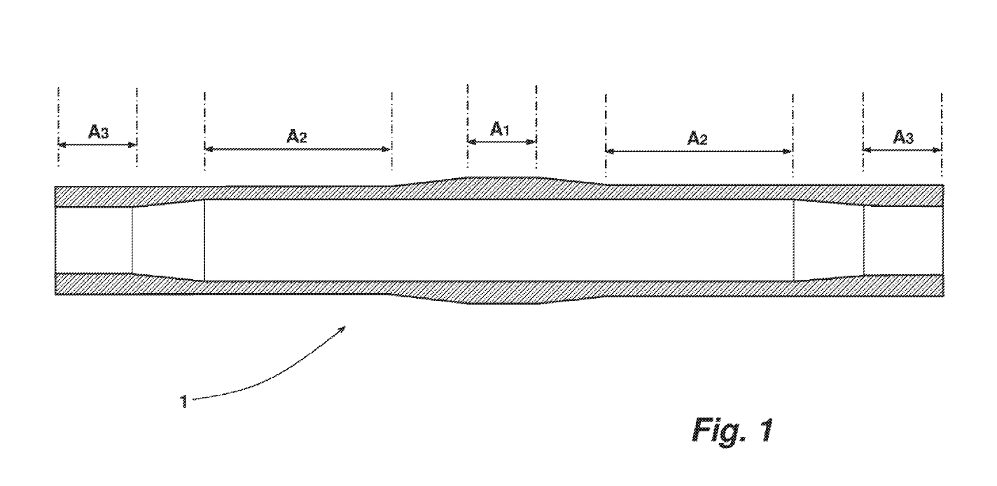

FIG. 1 shows a schematic longitudinal section of a light metal tube 1 for forming a drill tube as used for deep drilled holes. The longitudinal extension light metal tube 1 shown in FIG. 1 is not to scale. The length/diameter ratio is indeed much smaller than shown in this schematic drawing.

The light metal tube 1 has sections of different wall thicknesses in its longitudinal extension. The tube 1 of the exemplary embodiment shown is symmetrically configured with respect to its center towards its ends. The central section A₁ of the light metal tube 1 has a greater wall thickness than its adjacent sections. Sections A₂ of a smaller wall thickness are located on both sides adjacent to section A₁. A continuous transition is provided between sections A₁ and A₂, wherein the wall thickness increases gradually from section A₂ to section A₁. An end section A₃, which again has a greater wall thickness compared to section A₂, is located adjacent to each of the sections A₂. There is a transitional section between each section A₂ and A₃ as well, in which the wall thickness continuously and gradually transitions from the wall thickness of section A₂ to the wall thickness of section A₃. The difference in wall thickness between the section A₁, A₃, and A₂ is about 2 times.

It will be appreciated that the light metal tube does not necessarily need to be configured symmetrically in the longitudinal extension with respect to its center.

The light metal tube shown in FIG. 1 is comprised of an aluminum alloy having the following composition:

| Al | Si | Fe | Cu | Mn | Mg | Li | Zn | V | Ti | Zr | Ag |
|---|---|---|---|---|---|---|---|---|---|---|---|
| 94.27 | 0.02 | 0.04 | 3.86 | 0.01 | 0.38 | 0.8 | 0.02 | 0.005 | 0.03 | 0.1 | 0.36 |

The light metal tube, which was homogenized after continuous casting and then extruded, was solution annealed after forming and then drawn out to a draw-out ratio of 4.6 in the sections A₂ with the smallest wall thickness. Due to the differences in wall thickness between the sections A₂ and the sections A₁ and A₃, respectively, these sections remain unaffected by the drawing process.

The end sections A₃ are thickened compared to their adjacent sections A₂, since contours are to be machined into the outer circumferential surface to connect a coupling piece to the exemplary embodiment described. The light metal tube 1 forms the actual drill tube only with the coupling pieces not shown in the figure. It will be appreciated that the thickened sections A₃ can also be used to incorporate the coupling geometries therein. The sections A₃ are machined for incorporating the desired retention geometry, such as threads or the like, after drawing out and artificial aging. This utilizes the fact that the sections A₃ of the light metal tube 1 are unaffected by the drawing process and did not become hardened by it.

The alloy used is an alloy which is sensitive to drawing, which means that the wall sections that were indeed drawn out were hardened depending on the draw-out ratio. In an illustrated embodiment, these are primarily the sections A₂ and, to a successively decreasing extent, the transitional areas towards the respective thicker wall section. Drawing out the light metal tube 1 before machining the ends has the result that the tube is given sufficient strength and dimensional stability.

In a subsequent step, the light metal tube 1 was subjected to hot curing by artificial aging. Artificial aging was performed at 170° C. for 36 hours. In the process of artificial aging, the strength set by drawing in the A₂ sections was minimally reduced, however the sections not hardened by the drawing process—sections A₁, A₃ and the transitional sections that were not drawn out—were hot cured by the artificial aging process.

Samples were taken from sections A₁, A₂ and A₃ of the light metal tube 1 to determine the strength values. The strength values determined in this context can be seen in the table below:

| | | Draw-out | Rₚ₀₂ | Rₘ | A_{g} | A₅ |
|---|---|---|---|---|---|---|
| Pos. | Direction | ratio | [MPa] | [MPa] | [%] | [%] |
| A₃ | L | 0.8 | 525 | 575 | 5.2 | 9.8 |
| A₂ | | 4.6 | 573 | 604 | 4.5 | 11.8 |
| A₁ | | 0 | 498 | 539 | 4.7 | 9.5 |
| A₂ | | 4.6 | 572 | 602 | 4.6 | 11.2 |
| A₃ | | 0.8 | 523 | 574 | 4.5 | 8.8 |
| A₃ | LT | 0.8 | 515 | 556 | 4.2 | 7.2 |
| A₂ | | 4.6 | 556 | 585 | 4.2 | 7.9 |
| A₁ | | 0 | 497 | 542 | 5.5 | 9.3 |
| A₂ | | 4.6 | 548 | 580 | 4.3 | 7.3 |
| A₃ | | 0.8 | 515 | 556 | 4.2 | 7.2 |

The strength values listed in the table include the 0.2% yield strength (Rₚ₀₂), tensile strength (Rₘ), uniform elongation (A_{g}), and elongation at break (As).

The strength values listed in the table, which were achieved for the light metal tube, exceed those strength values that were determined for a comparison tube made of an AA 2014 alloy by 20% to 30%. These strength values also make it apparent that even the non-drawn section A₁ is of sufficient strength after artificial aging and that the difference in strength between sections of smaller wall thickness A₂ and those of greater wall thickness A₁, A₃, while existing, is not critical. The lower strength values determined in the sections of greater wall thickness are easily compensated by their greater wall thickness.

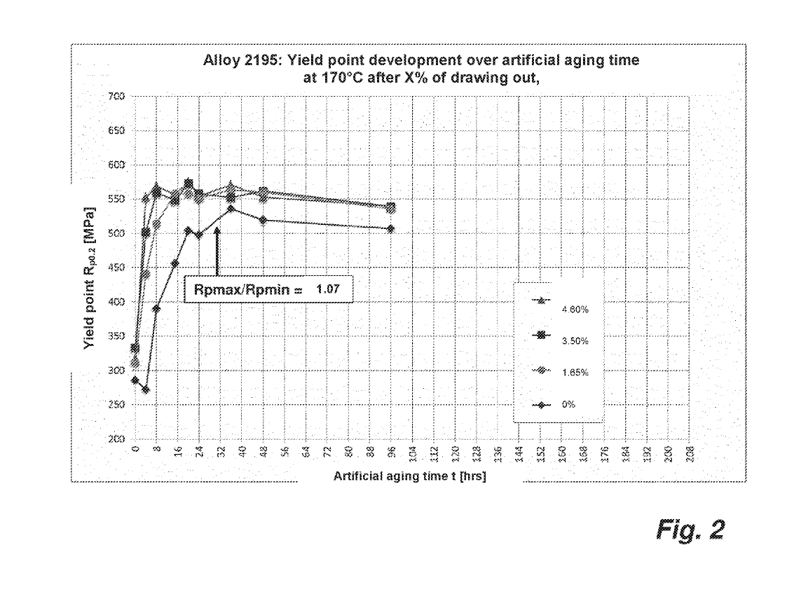

FIG. 2 shows the yield strength development over the artificial aging time of a tube according to the one shown in FIG. 1 having a different draw-out ratio. Artificial aging was performed at 170° C., as explained above. The curves indicate that increasing the artificial aging time to over 40 hours no longer has any positive effects. It can therefore be kept short. But above all, the curve referring to a drill tube section that has remained non-drawn shows that the strength was increased to a sufficiently high level in the course of artificial aging. It will be appreciated that the strength of the tube in the non-drawn sections is more than compensated by the respective thicker walls.

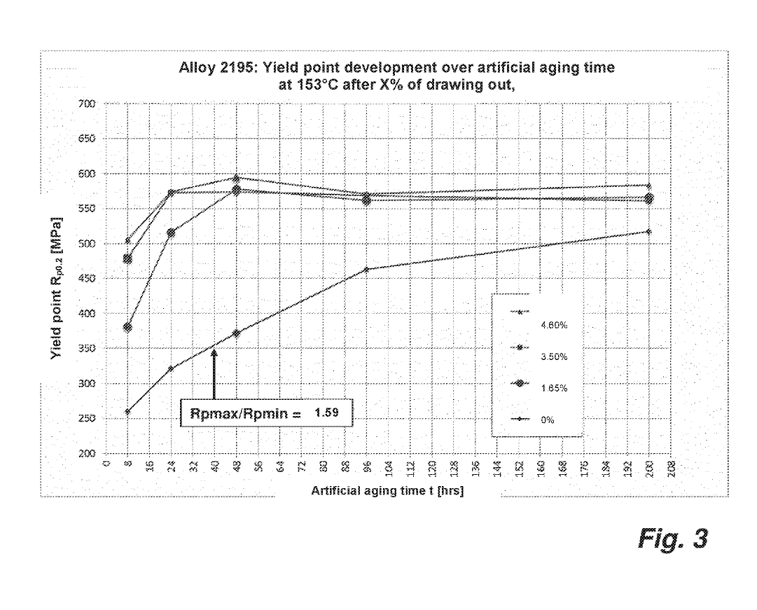

FIG. 3 is a comparison of analogous samples after an artificial aging test, wherein artificial aging was performed using parameters from conventional practices, namely at 153° C. It is apparent, on the one hand, that the non-drawn sample or non-drawn tube section achieves acceptable strength properties after an unacceptably long artificial aging time (>200 h) only. In the aging time needed for artificial aging at 170° C. for achieving acceptable strength properties, the non-drawn tube sections do not reach sufficient strength properties if artificial aging is performed at 153° C.

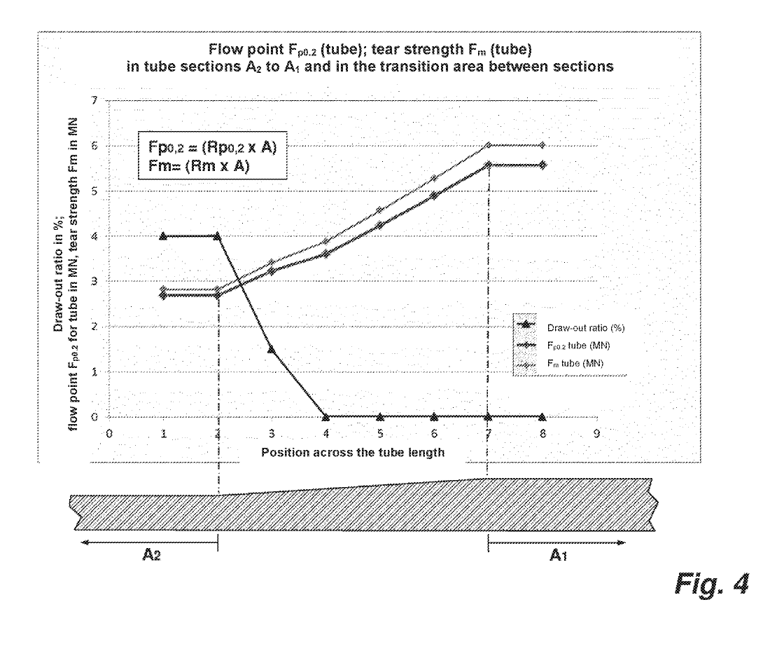

FIG. 4 shows the drawing behavior, flow point and tear strength at the transition from a section of tube 1 having a thinner wall thickness—section A₂- to a section having a thicker wall thickness—section A₁. When the tube 1 is drawn out as described above, the sections of thinner wall thickness are drawn out to the desired extent (here: 4%). This draw-out ratio decreases successively in the transitional area from section A₂ to section A₁. The tube is no longer drawn out after just ⅖ of the transition length towards wall section A₂.

The curves for flow point and tear strength are shown in comparison to the curve for the draw-out ratio. The increase in flow point and tear strength from the tube section A₂, having a thinner wall thickness, to the tube section A₁, having a greater wall thickness, makes it clear that an increase in wall thickness more than compensates for the disadvantages of non-drawing in these sections. It is also due to the artificial aging method described above that the tube 1 has a significantly higher tear strength and flow point in the sections of greater wall thickness.

The invention was described based on exemplary embodiments. A person skilled in the art will derive numerous embodiments for implementing the invention without departing from the scope of the present claims. While a number of aspects and embodiments have been discussed above, those of skill in the art will recognize certain modifications, permutations, additions and sub-combinations therefore. It is therefore intended that the following appended claims hereinafter introduced are interpreted to include all such modifications, permutations, additions and sub-combinations, which are within their true spirit and scope. Each embodiment described herein has numerous equivalents.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims. Whenever a range is given in the specification, all intermediate ranges and subranges, as well as all individual values included in the ranges given are intended to be included in the disclosure. When a Markush group or other grouping is used herein, all individual members of the group and all combinations and sub-combinations possible of the group are intended to be individually included in the disclosure.

In general, the terms and phrases used herein have their art-recognized meaning, which can be found by reference to standard texts, journal references and contexts known to those skilled in the art. The above definitions are provided to clarify their specific use in the context of the invention.

1-14. (canceled)

15. A tube for use in conjunction with a deep drilled hole, comprising: a light metal tube made of an aluminum alloy, having sections of different wall thicknesses arranged in the longitudinal direction of the tube and a respective coupling at each end for connecting the tube to a further tube;
wherein the sections of different wall thicknesses comprise sections of smaller wall thickness, sections of greater wall thickness, and transitional sections;
wherein the light metal tube is made of an aluminum alloy which contains the following elements:
2.5-5.0 wt % Cu,
0.2-1.0 wt % Mg,
0.8-2.0 wt % Li,
max. 0.15 wt % Si,
max. 0.15 wt % Fe,
max. 0.5 wt % Mn,
max. 1.0 wt % Zn,
max. 0.1 wt % Ti,
max. 0.5 wt % Ag,
remaining Al and unavoidable impurities.

16. The tube of claim 15, wherein the composition of the aluminum alloy of the light metal tube has the following composition:
3.5-4.5 wt % Cu,
0.2-0.8 wt % Mg,
0.8-1.3 wt % Li,
0.1-0.4 wt % Mn,
0.02-0.07 wt % Ti,
max. 0.15 wt % Si,
max. 0.15 wt % Fe,
max. 0.5 wt % Ag,
remaining Al and unavoidable impurities.

17. The tube of claim 15, wherein the composition of the aluminum alloy of the light metal tube has a silver content of 0.2-0.5 wt %.

18. The tube of claim 15, wherein the composition of the aluminum alloy of the light metal tube has the following composition:
3.0-3.5 wt % Cu,
0.28-0.25 wt % Mg,
0.9-1.2 wt % Li,
0.28-0.40 wt % Mn,
0.035-0.06 wt % Ti,
max. 0.15 wt % Si,
max. 0.15 wt % Fe,
remaining Al and unavoidable impurities.

19. The tube of claim 15, wherein the composition of the aluminum alloy of the light metal tube contains one or several of the following elements:
max. 0.2 wt % Cr,
max. 0.2 wt % Zr,
max. 0.2 wt % Sc,
max. 0.2 wt % Hf,
max. 0.2 wt % V,
wherein the sum total of the elements Cr, Zr, Sc, Hf, and V does not exceed 0.3 wt %.

21. The tube of claim 16, wherein the composition of the aluminum alloy of the light metal tube has a silver content of 0.2-0.5 wt %.

22. The tube of claim 16, wherein the composition of the aluminum alloy of the light metal tube has the following composition:
3.0-3.5 wt % Cu,
0.28-0.25 wt % Mg,
0.9-1.2 wt % Li,
0.28-0.40 wt % Mn,
0.035-0.06 wt % Ti,
max. 0.15 wt % Si,
max. 0.15 wt % Fe,
remaining Al and unavoidable impurities.

23. The tube of claim 17, wherein the composition of the aluminum alloy of the light metal tube has the following composition:
3.0-3.5 wt % Cu,
0.28-0.25 wt % Mg,
0.9-1.2 wt % Li,
0.28-0.40 wt % Mn,
0.035-0.06 wt % Ti,
max. 0.15 wt % Si,
max. 0.15 wt % Fe,
remaining Al and unavoidable impurities.

24. The tube of claim 16, wherein the composition of the aluminum alloy of the light metal tube in addition contains one or several of the following elements:
max. 0.2 wt % Cr,
max. 0.2 wt % Zr,
max. 0.2 wt % Sc,
max. 0.2 wt % Hf,
max. 0.2 wt % V,
wherein the sum total of the elements Cr, Zr, Sc, Hf, and V does not exceed 0.3 wt %.

25. The tube of claim 18, wherein the composition of the aluminum alloy of the light metal tube in addition contains one or several of the following elements:
max. 0.2 wt % Cr,
max. 0.2 wt % Zr,
max. 0.2 wt % Sc,
max. 0.2 wt % Hf,
max. 0.2 wt % V,
wherein the sum total of the elements Cr, Zr, Sc, Hf, and V does not exceed 0.3 wt %.

26. The tube of claim 15, wherein the sections of different wall thicknesses comprise a section of smallest wall thickness, the tube has been drawn out by at least 2-2.5%, in the section of smallest wall thickness.

27. The tube of claim 26, wherein the tube has been drawn out by at least 3.5%.

28. The tube of claim 15, wherein the light metal tube comprises on each of its two ends a section having a greater wall thickness,
wherein the sections having a greater wall thickness are each separated from one another by a section having a smaller wall thickness and
wherein transitional sections in which the wall thickness continuously transitions from the one section to the other section are provided between sections having a greater wall thickness and those having a smaller wall thickness.

29. The tube of claim 28, wherein at least one further section having a greater wall thickness is arranged between the two end sections having a greater wall thickness, where the section having a greater wall thickness transitions into the adjacent sections having a smaller wall thickness via a transitional section.

30. The tube of claim 28, wherein the couplings are incorporated into the end sections of the light metal tube.

31. The tube of claim 15, wherein the tube is a drill tube for forming a drill rod assembly.

32. A method of manufacturing a light metal tube of claim 15, wherein the light metal tube is formed using an extrusion process and subsequently solution annealed;
the extruded tube is then drawn out over its entire length until the section or sections having the smallest wall thickness are drawn out by at least 2 to 2.5%, and
the drawn light metal tube is artificially aged in a subsequent process step at a temperature between 164° C. and 180° C.

33. The method of claim 32, wherein the extruded light metal tube is then drawn out in its sections having the smallest wall thickness by at least 3.5%.

34. The method of claim 32, wherein the drawn out light metal tube is artificially aged for 24-45 hours.

35. The method of claim 32, wherein the artificial aging of the drawn out light metal tube is performed within a temperature range between 168° C. to 172° C., for 32-38 hours.
